(19) United States
(12) Patent Application Publication
(10) Pub. No.: US 2024/0117904 A1
(43) Pub. Date: Apr. 11, 2024

(54) SEALING RING AND PIPE CONNECTION

(71) Applicant: Walter Stauffenberg GmbH & Co. KG, Werdohl (DE)

(72) Inventors: Alexander AUL, Unna (DE); Necip CIVELEK, Werdohl (DE); Ulrich KOENIG, Herscheid (DE)

(73) Assignee: Walter Stauffenberg GmbH & Co. KG, Werdohl (DE)

(21) Appl. No.: 18/269,006

(22) PCT Filed: Nov. 22, 2021
(86) PCT No.: PCT/EP2021/082420

§ 371 Date: Jun. 22, 2023

(30) Foreign Application Priority Data
Dec. 23, 2020 (EP) 20216821.7

(51) Int. Cl. F16L 19/02; F16L 19/028

(52) U.S. Cl. CPC F16L 19/0218; F16L 19/0286

(57) ABSTRACT

A pipe connection includes a connection body, a nut which can be screwed onto or into the latter and which has a conical bore which widens toward the connection body, and a pipe guided through a bore in the nut and having an outwardly projecting formation with two clamping faces. A first clamping face is parallel to the end face of the connection body and is supported on the connection body at least in certain regions when the pipe connection is in the clamped state, and the second clamping face is cone-shaped in a manner corresponding to the conical bore in the nut and is supported in the conical bore in the nut. The connection body has a radially encircling cutout by which a receiving space is formed for a sealing ring that is delimited by the first clamping face and has a polygonal, symmetrical cross section.

The invention relates to a pipe connection in accordance with the preamble of claim 1. The invention furthermore relates to a sealing ring for a pipe connection in accordance with the preamble of claim 7.

For implementation of screwed pipe connections, pipe connections are known that comprise a connection body that holds the pipe end to be connected and onto which a nut can be screwed. The connection body has a cylindrical bore for holding the pipe end, wherein the pipe end is provided with a formed part that projects outward, the first clamping face of which part lies against the end face of the connection body. A second clamping face of the formed part is configured to be conical and lies against a conical bore of the nut. By tightening the screw connection between nut and connection body, the formed part that projects outward can be pressed against the end face of the connection body. To seal the connection body relative to the pipe held by it, the connection body is provided with a conical bore that extends all the way to the end face of the connection body and widens in the direction toward the end face, and thereby a holder for a sealing ring is formed between connection body and pipe. The sealing ring has an essentially triangular cross-section, corresponding to the holder that is formed. Such a pipe connection is known, for example, from DE 195 26 316 A1.

In the case of pipe connections of the aforementioned type, it can happen, depending on the configuration of the sealing ring, that the sealing ring is twisted or actually everted completely during the course of installation, and thereby the sealing effect and also the durability of the sealing ring can be impaired.

This is where the invention seeks to provide a remedy. The invention is based on the task of making available a pipe connection of the aforementioned type, which can be produced with minimized effort and in which twisting or eversion of the sealing ring is prevented. According to the invention, this task is accomplished by means of the characteristics of the characterizing part of claim 1.

With the invention, a pipe connection of the aforementioned type is created, in which twisting or eversion of the sealing ring is prevented. Because of the fact that the sealing ring has a polygonal, symmetrical cross-section, it is guaranteed that a force applied to one side generates a corresponding opposite force, and thereby a symmetrical pressure distribution in the sealing ring is achieved. It has been shown that a polygonal sealing ring having a symmetrical pressure distribution has a significantly lesser tendency toward twisting or eversion. Furthermore, the sealing ring fulfills its function even if it is “everted.”

Preferably the recess is formed by means of a conical bore that extends all the way to the end face of the connection body and widens in the direction toward the end face, which bore opens, at its smallest diameter, into a cylindrical bore of the connection body, the inside diameter of which bore preferably corresponds essentially to the outside diameter of the end section of the pipe held by the connection piece.

In a further development of the invention, the first clamping face of the pipe makes a transition into a connection surface, which narrows conically in the direction of the cylindrical end section of the pipe. In this way, an angled transition for holding a peak line of the sealing ring is formed, and thereby stable positioning of the sealing ring is made possible.

In an embodiment of the invention, the sealing ring has a pentagonal or hexagonal cross-section. In this way, contact sides for sealing the sealing surfaces of a pipe connection are formed, which sides are connected by way of peak lines, which allow the formation of directed reset forces. Alternatively, the cross-section of the sealing ring can also have more than six corners. In this regard, in the present case, the term “corner” or “angular” also subsumes a radius, in the present case, which connects two surfaces set at an angle relative to one another.

In the present case, a “peak line” is understood to mean a linear outer corner produced by means of the angled positioning of two planes (corresponds to the roof ridge of a gabled roof).

In a further embodiment of the invention, the cross-section of the sealing ring is configured to be hexagonal, wherein the cross-section is formed from two base sides arranged parallel to one another and angled away outward in the manner of a gabled roof, which sides are connected with one another by way of two outer sides that are shorter as compared with the base sides. Preferably the corners of the cross-section of the sealing ring are configured to be rounded off by way of a radius.

The invention is furthermore based on the task of making available a sealing ring for a pipe connection of the aforementioned type, which connection can be produced with minimized effort and in which twisting or eversion of the sealing ring is prevented. According to the invention, this task is accomplished by means of the characteristics of the characterizing part of claim 7.

In an embodiment of the invention, the cross-section is configured to be pentagonal or hexagonal. Preferably the cross-section is configured to be hexagonal, wherein the cross-section is formed from two base sides arranged parallel to one another and angled away outward in the manner of a gabled roof, which sides are connected with one another by way of two outer sides that are shorter as compared with the base sides. Preferably the corners of the cross-section of the sealing ring are configured to be rounded off by way of a radius.

Other further developments and embodiments of the invention are indicated in the remaining dependent claims. An exemplary embodiment of the invention is shown in the drawings and will be described in detail below. The figures show:

FIG. 1 the schematic representation of a pipe connection;

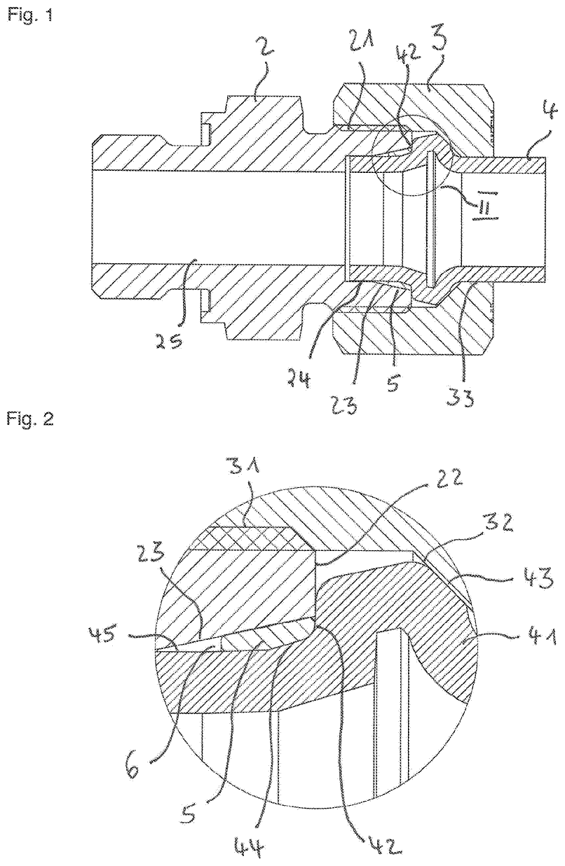

FIG. 2 the enlarged detail representation of the detail II from FIG. 1;

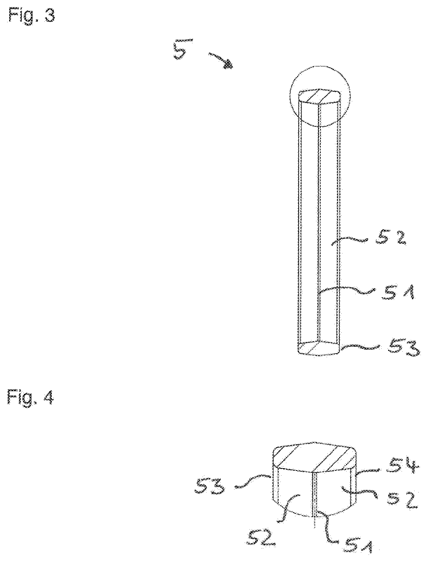

FIG. 3 the schematic representation of the sealing ring of the pipe connection from FIG. 1, and

FIG. 4 the enlarged detail representation of the detail IV of the sealing ring from FIG. 3.

The pipe connection 1 selected as the exemplary embodiment essentially consists of a connection body 2 that holds a pipe 4 and onto which a nut 3 is screwed, wherein a sealing ring 5 is arranged between pipe 4 and connection body 2.

The connection body 2 is shown in part in FIG. 1, specifically with regard to the connection with the end section of the pipe 4. The further end can be provided once again, in accordance with this representation, so that the connection body 2 serves for connecting two pipes. Alternatively, this body can also be provided, at the end that is not shown, with a thread for connecting it onto or into a threaded piece. On the connection body 2, circumferentially on the outside, an outside thread 21 is provided for screwing the nut 3 on, which thread extends all the way to the end face 22 of the body. Along its center axis, the connection body 2 has a passage bore 25, which opens into a cylindrical bore 24 that is widened in diameter, followed by a conical bore 23 that is configured to widen in the direction of the end face 22.

The nut 3 is screwed onto the outside thread 21 of the connection body 2; for this purpose, the nut is provided with an inside thread 31. The nut 3 has a conical bore 32 that is configured to widen in the direction of the connection body 2. The conical bore 32 of the nut 3 is followed by a passage bore 33 through which the pipe 4 is passed.

A formed part 41 is formed into the end-side section of the pipe 4, the outside diameter of which essentially corresponds to the inside diameter of the cylindrical bore 24 of the connection body 2. The formed part 41 has a first clamping surface 42 that is set essentially orthogonal to the center rotational axis of the pipe 4 and lies against the end face 22 of the connection body 2. The first clamping surface 42 makes a transition into a connection surface 44, which narrows conically in the direction of the cylindrical end section 45.

The second clamping surface 43, which lies opposite the first clamping surface 42, is configured to be conical, wherein the progression of this second clamping surface 43 essentially corresponds to the conical bore 32 of the nut 3, against which the formed part 41 lies with its second clamping surface 43.

By means of the conical bore 23 of the connection body 2 and the end-side section of the pipe 4, with its first clamping surface 4 and its connection surface 45, a ring-shaped holding space 6 is delimited, having an essentially square-shaped cross-section for holding the sealing ring 5, which is pushed onto the pipe 4.

In FIGS. 3 and 4, the sealing ring 5 is shown enlarged. It has an essentially hexagonal cross-section that is formed from two base sides arranged parallel to one another and angled away outward in the manner of a gabled roof, which sides are connected with one another by way of two shorter outer sides. As a result, the sealing ring 5 has four wide sealing surfaces 52, which narrow conically outward from a peak line 51, in each instance, and open into one of two straight, narrow sealing surfaces 53 that are arranged parallel to one another. The “corners” of the hexagonal cross-section are configured to be rounded off by way of a radius 54. In the exemplary embodiment, the sealing ring is produced from rubber. Furthermore, it can also be produced from another elastomer material.

As is particularly evident from FIG. 2, the sealing ring 5 lies against the first clamping surface 42 of the formed part 41 of the pipe 4 with a narrow sealing surface 53, and runs along the connection surface 44 with a wide sealing surface 52 of its inner contour. The second wide sealing surface 52 of the inner contour of the sealing ring 5 lies against the cylindrical end section 45, wherein the peak line 51 formed between these two inner wide sealing surfaces 52 lies against the angled transition between connection surface 44 and cylindrical section 45. The two outer wide sealing surfaces 52 of the sealing ring 5 are pressed against the inside wall of the conical bore 23 in such a manner that they form a common level surface. By means of the reset forces formed in this way, the sealing ring is pressed against both the transition between connection surface 44 and cylindrical section 45 and against the sealing gap between the end face 22 of the connection body 2 and the first clamping surface 42 of the pipe 4. Extrusion into the gap as well as twisting of the sealing ring 5 is reliably prevented by means of this configuration. In the exemplary embodiment, the cross-section of the sealing ring 5 is configured as a symmetrical hexagon. Depending on the configuration of the sealing gap, the cross-section can also have a different polygonal shape.

1. A pipe connection (1) having a connection body (2), a nut (3) that can be screwed onto or into this body, which nut has a conical bore (32) that widens in the direction of the connection body (2), and a pipe (4) that is passed through a bore (33) of the nut and has a formed part (41) that projects outward, having two clamping surfaces (42, 43), of which a first clamping surface (42) is parallel to the end face (22) of the connection body (2) and is supported, at least in certain regions, on the connection body (2), in the braced state of the pipe connection (1), and the second clamping surface (42) is configured to be conical, corresponding to the conical bore (32) of the nut (3), and is supported in the conical bore (32) of the nut (3), wherein the connection body (2) has a radially circumferential recess, by means of which a holding space (6) for a sealing ring (5) is formed, which space is delimited by the first clamping surface (42), wherein the sealing ring (5) has a polygonal, symmetrical cross-section.

2. The pipe connection according to claim 1, wherein the recess is formed by means of a conical bore (23) that extends all the way to the end face (22) of the connection body (2) and widens in the direction toward the end face (22), which bore opens, at its smallest diameter, into a cylindrical bore (24) of the connection body (2), the inside diameter of which bore preferably corresponds essentially to the outside diameter of the end section of the pipe (4) held by the connection piece (2).

3. The pipe connection according to claim 1, wherein the first clamping surface (42) of the pipe (4) makes a transition into a connection surface (44) that narrows conically in the direction of the cylindrical end section (45) of the pipe (4).

4. The pipe connection according to claim 1, wherein the cross-section of the sealing ring (5) is configured to be pentagonal or hexagonal.

5. The pipe connection according to claim 4, wherein the cross-section of the sealing ring (5) is configured to be hexagonal, wherein the cross-section is formed from two base sides arranged parallel to one another and angled away outward in the manner of a gabled roof, which sides are connected with one another by way of two outer sides that are shorter as compared with the base sides.

6. The pipe connection according to claim 5, wherein the corners of the cross-section of the sealing ring (5) are configured to be rounded off by way of a radius (54).

7. A sealing ring (5) for the pipe connection (1) according to claim 1 wherein the sealing ring has a polygonal, symmetrical cross-section.

8. The sealing ring according to claim 7, wherein the cross-section is configured to be pentagonal or hexagonal.

9. The sealing ring according to claim 8, wherein the cross-section is configured to be hexagonal, wherein the cross-section is formed from two base sides arranged parallel to one another and angled away outward in the manner of a gabled roof, which sides are connected with one another by way of two outer sides that are shorter as compared with the base sides.

10. The sealing ring according to claim 9, wherein the corners of the cross-section are configured to be rounded off by way of a radius (54).
